(19) United States
(12) Patent Application Publication
(10) Pub. No.: US 2020/0364567 A1
(43) Pub. Date: Nov. 19, 2020

(54) NEURAL NETWORK DEVICE FOR SELECTING ACTION CORRESPONDING TO CURRENT STATE BASED ON GAUSSIAN VALUE DISTRIBUTION AND ACTION SELECTING METHOD USING THE NEURAL NETWORK DEVICE

(71) Applicant: Samsung Electronics Co., Ltd., Suwon-si (KR)

(72) Inventors: Songhwai OH, Seoul (KR); Yunho CHOI, Seoul (KR); Kyungjae LEE, Seoul (KR)

(73) Assignees: Samsung Electronics Co., Ltd., Suwon-si (KR); SEOUL NATIONAL UNIVERSITY R&DB FOUNDATION, Seoul (KR)

(21) Appl. No.: 16/875,170

(22) Filed: May 15, 2020

(30) Foreign Application Priority Data
May 17, 2019 (KR) 10-2019-0058376
Feb. 5, 2020 (KR) 10-2020-0013731

(51) Int. Cl. G06N 3/08; G06N 3/04

(52) U.S. Cl. CPC G06N 3/08; G06N 3/04

(57) ABSTRACT

A neural network device and an action selecting method using the same, which select an action corresponding to a current state on the basis of a value return. A method of selecting, executed by at least one processor, an action on the basis of deep learning includes receiving a current state as an input, calculating a value distribution corresponding to each of a plurality of actions to be performed on the current state, and selecting an optimal action from among the plurality of actions based on the value distribution, wherein the value distribution includes at least one Gaussian graph following a Gaussian distribution.

### CROSS-REFERENCE TO RELATED APPLICATIONS

This application claims the benefit of Korean Patent Application Nos. 10-2019-0058376, filed on May 17, 2019, and 10-2020-0013731, filed on Feb. 5, 2020, in the Korean Intellectual Property Office, the disclosures of which are incorporated herein in their entireties by reference.

### BACKGROUND

The inventive concepts relate to a neural network device, and more particularly, to a neural network device and an action selecting method using the same, which select an action corresponding to a current state on the basis of a value return.

A neural network refers to a computational architecture obtained by modeling a biological brain. Recently, as neural network technology advances, research for analyzing input data by using a neural network device using one or more neural network models and extracting valid information in various kinds of electronic devices is being actively done.

Machine learning is the field of artificial intelligence (AI) using a neural network and denotes technology which inputs data to a computer to allow the computer to learn the data, thereby generating new knowledge. Particularly, neural network field which is a kind of machine learning technology has considerably advanced, and thus, deep learning has been developed.

The deep learning is a kind of machine learning technology based on an artificial neural network, and although the artificial neural network is designed in a multi-layer structure and thus is deepened, unsupervised learning preprocessing may be performed on pieces of data for learning, thereby enhancing learning efficiency. Particularly, big data based on Internet and computing performance for processing the big data have been enhanced, and thus, the deep learning has advanced rapidly.

### SUMMARY

The inventive concepts provide a neural network device and an action selecting method using the same, which select an optimal action corresponding to a current state on the basis of a value return.

The inventive concepts provide a neural network device and an action selecting method using the same, which determine a kernel weight for selecting an optimal action.

According to an aspect of the inventive concepts, there is provided a method of selecting an action based on deep learning, executed by a device including a neural network device, includes receiving, by the neural network device, a current state as an input, calculating, by the neural network device, a value distribution corresponding to each of a plurality of actions to be performed on the current state, and selecting, by the neural network device, an action from among the plurality of actions based on the value distribution, wherein the value distribution includes at least one Gaussian graph following a Gaussian distribution.

According to another aspect of the inventive concepts, there is provided a method of selecting an action based on deep learning, executed by a device including a neural network device, the method including receiving, by the neural network device, a current state as an input, performing, by the neural network device, a convolution operation on an input feature map corresponding to the current state by using a weight kernel, and setting, by the neural network device, the weight kernel for minimizing a distance difference between a first value distribution corresponding to the current state and a second value distribution corresponding to a calculation value of the current state, wherein the first value distribution includes a plurality of first Gaussian graphs corresponding to value returns of the current state, and the second value distribution includes a plurality of second Gaussian graphs corresponding to a sum of value returns of a state next to the current state and value returns of the plurality of actions.

According to another aspect of the inventive concepts, there is provided a neural network device including a deep learning module configured to receive a current state and calculate a value distribution corresponding to each of a plurality of actions to be performed on the current state by using a deep learning model and a post-processing module configured to select an optimal action from among the plurality of actions based on the value distribution, wherein the value distribution includes at least one Gaussian graph following a Gaussian distribution.

### BRIEF DESCRIPTION OF THE DRAWINGS

Example embodiments of the inventive concepts will be more clearly understood from the following detailed description taken in conjunction with the accompanying drawings in which:

FIG. 1 is a block diagram illustrating an electronic system according to an embodiment;

FIG. 2 is a block diagram illustrating an electronic system according to an embodiment;

FIG. 3 is a block diagram illustrating a neural network device according to an embodiment;

FIG. 4 is a flowchart illustrating an operating method of a neural network device according to an embodiment;

FIG. 5 is a diagram illustrating a neural network according to an embodiment;

FIGS. 6A and 6B are diagrams for describing a convolution operation of a neural network according to an embodiment;

FIG. 7 is a diagram illustrating a neural network according to an embodiment;

FIG. 8 is a flowchart illustrating an operating method of a neural network device according to an embodiment;

FIG. 9 is a diagram illustrating an operation of a neural network device according to an embodiment;

FIG. 10 is a flowchart illustrating an operating method of a neural network device according to an embodiment;

FIG. 11 is a diagram illustrating an operation of a neural network device according to an embodiment;

FIG. 12 is a flowchart illustrating an operating method of an electronic system according to an embodiment;

FIG. 13 is a block diagram illustrating a neural network device according to an embodiment; and

FIG. 14 is a block diagram illustrating an application processor according to an embodiment.

### DETAILED DESCRIPTION OF THE EMBODIMENTS

Hereinafter, example embodiments will be described in detail with reference to the accompanying drawings.

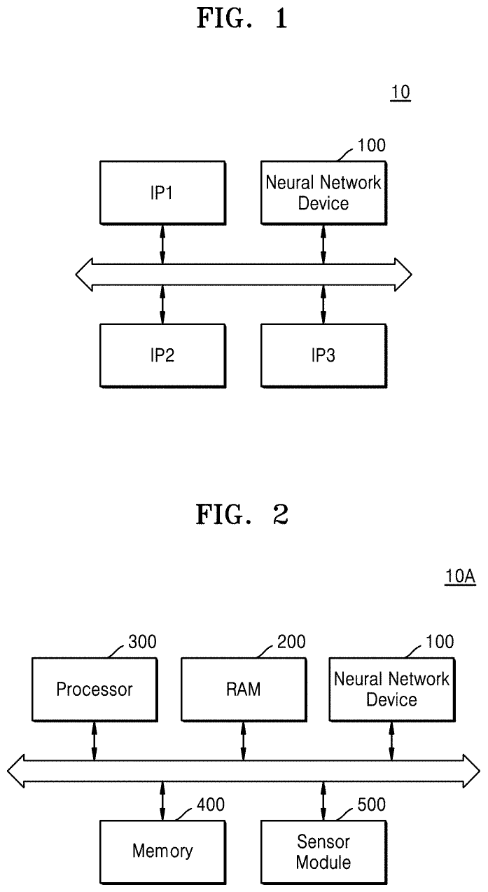

FIG. 1 is a block diagram illustrating an electronic system 10 according to an embodiment.

Referring to FIG. 1, the electronic system 10 may analyze input data in real time on the basis of a neural network to extract valid information and/or may check a state on the basis of the extracted information and/or may control elements of an electronic device equipped with the electronic system 10. For example, the electronic system 10 may be applied to drones, an advanced drivers assistance system (ADAS), robot devices, smart televisions (TVs), smartphones, medical apparatuses, mobile devices, image display devices, measurement devices, Internet of things (IoT) devices, etc., and moreover, may be equipped in various kinds of electronic devices.

The electronic system 10 may include at least one intellectual property (IP) block and a neural network device 100. For example, the electronic system 10 may include first to third IP blocks IP1 to IP3 and a neural network device 100.

The electronic system 10 may include various kinds of IP blocks. For example, the IP blocks may include a processing circuitry, a plurality of cores included in the processing circuitry, a multi-format codec (MFC), a video module (for example, a camera interface, a joint photographic experts group (JPEG) processor, a video processor, a mixer, or the like), a three-dimensional (3D) graphics core, an audio system, a driver, a display driver, volatile memory, non-volatile memory, a memory controller, an input and output interface block, cache memory, and/or the like. Each of the first to third IP blocks IP1 to IP3 may include at least one of the various kinds of IP blocks.

Technology for connecting IP blocks may include a connection manner based on a system bus. For example, an advanced microcontroller bus architecture (AMBA) protocol of Advanced RISC Machine (ARM) may be applied as a standard bus protocol. Bus types of the AMBA protocol may include advanced high-performance bus (AHB), advanced peripheral bus (APB), advanced extensible interface (AXI), AXI4, and AXI coherency extensions (ACE). Among the bus types described above, AXI may be an interface protocol between the IP blocks and may provide a multiple outstanding address function and a data interleaving function. In addition, other types of protocol, such as uNetwork of SONICs Inc., CoreConnect of IBM Inc., or open core protocol of OCP-IP, may be applied to the system bus.

The neural network device 100 may be configured to generate a neural network, train and/or learn the neural network, and/or perform an arithmetic operation on the basis of input data received thereby and may generate an information signal on the basis of a performing result and/or may retrain the neural network. Models of the neural network may include various kinds of models such as GoogleNet, AlexNet, convolution neural network (CNN) such as VGG network, region with convolution neural network (R-CNN), region proposal network (RPN), recurrent neural network (RNN), stacking-based deep neural network (S-DNN), state-space dynamic neural network (S-SDNN), deconvolution network, deep belief network (DBN), restricted Boltzman machine (RBM), fully convolutional network, long short-term memory (LS TM) network, classification network, deep Q-network (DQN), and distribution reinforcement learning, but are not limited thereto. The neural network device 100 may include one or more processors for performing an arithmetic operation based on the models of the neural network. Also, the neural network device 100 may include a separate memory for storing programs corresponding to the models of the neural network. The neural network device 100 may be referred to as a neural network processing device, a neural network integrated circuit, a neural network processing unit (NPU), or a deep learning device.

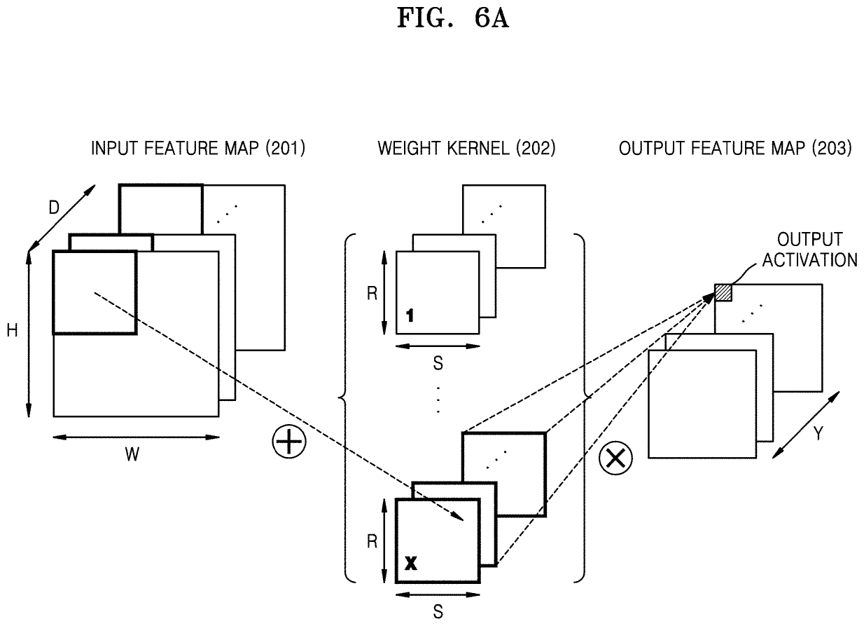

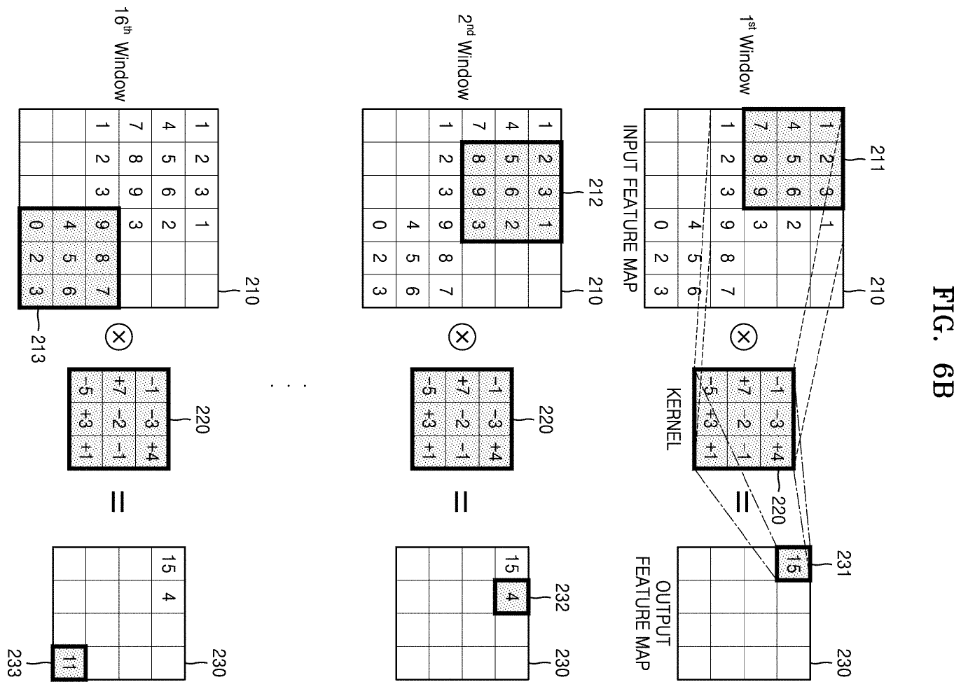

The neural network device 100 may be configured to receive various kinds of pieces of input data from at least one IP block through the system bus and may generate an information signal on the basis of the input data. For example, the neural network device 100 may perform a neural network operation on the input data to generate the information signal, and the neural network operation may include a convolution operation. The convolution operation of the neural network device 100 will be described in more detail with reference to FIGS. 6A and 6B.

The information signal generated by the neural network device 100 may include at least one of various kinds of recognition signals such as a voice recognition signal, an object recognition signal, an image recognition signal, and a biometric information recognition signal. For example, the neural network device 100 may receive, as input data, frame data included in a video stream and may generate a recognition signal, corresponding to an object included in an image represented by the frame data, from the frame data. However, the present embodiment is not limited thereto, and the neural network device 100 may receive various kinds of input data and may generate a recognition signal based on the input data.

The electronic system 10, according to an embodiment, may be configured to use a value distribution so as to select an action from among a plurality of actions corresponding to a current state received as an input, and the value distribution may include at least one Gaussian graph. The selected action may be, for example, an optimal action from among the plurality of actions based on the value distribution. Also, the at least one Gaussian graph included in the value distribution may be defined by a value weight, a value mean, and a value standard deviation, and the electronic system 10 may output a value weight, a value mean, and a value standard deviation as a deep learning result of the neural network device 100 and may select an optimal action on the basis thereof.

FIG. 2 is a block diagram illustrating an electronic system 10A according to an embodiment. In detail, FIG. 2 illustrates a more detailed example embodiment than the electronic system 10 illustrated in FIG. 1. In describing the electronic system 10A of FIG. 2, description which is the same as or similar to the description of FIG. 1 is omitted.

Referring to FIG. 2, the electronic system 10A may include a neural network device 100, a random access memory (RAM) 200, a processor 300, a memory 400, and a sensor module 500. The neural network device 100 may be an element corresponding to the neural network device 100 of FIG. 1.

The RAM 200 may be configured to store programs, data, and/or instructions temporarily. For example, programs and/or data stored in the memory 400 may be temporarily loaded into the RAM 200 on the basis of a booting code and/or control by the processor 300. The RAM 200 may be implemented with memory such as dynamic RAM (DRAM) or static RAM (SRAM).

The processor 300 may be configured to control an overall operation of the electronic system 10A, and for example, the processor 300 may include processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), and programmable logic unit, a microprocessor, application-specific integrated circuit (ASIC), and the like. The processor 300 may include one processor core (a single core), or may include a plurality of processor cores (a multi-core). The processor 300 may process or execute the programs and/or the data each stored in the RAM 200 and the memory 400. For example, the processor 300 may execute the programs stored in the memory 400 to control functions of the electronic system 10A.

The memory 400 may be configured as a storage for storing data, and for example, may store an operating system (OS), various kinds of programs, and various pieces of data. The memory 400 may be DRAM, but is not limited thereto. The memory 400 may be at least one of a volatile memory and/or a non-volatile memory. The non-volatile memory may include read only memory (ROM), programmable ROM (PROM), electrically programmable ROM (EPROM), electrically erasable and programmable ROM (EEPROM), flash memory, phase-change RAM (PRAM), magnetic RAM (MRAM), resistive RAM (RRAM), ferroelectric RAM (FRAM), etc. The volatile memory may include dynamic RAM (DRAM), static RAM (SRAM), synchronous DRAM (SDRAM), phase-change RAM (PRAM), magnetic RAM (MRAM), resistive RAM (RRAM), ferroelectric RAM (FeRAM), etc. Also, in an embodiment, the memory 400 may include at least one of hard disk drive (HDD), solid state drive (SSD), compact flash (CF), secure digital (SD), micro-SD, mini-SD, extreme digital (xD), and memory stick.

The sensor module 500 may be configured to collect peripheral information about the electronic system 10A. The sensor module 500 may sense and/or receive a signal from the outside of the electronic system 10 and may convert the sensed and/or received signal into data. For example, the sensor module 500 may sense and/or receive an image signal and may convert the sensed or received image signal into image data, (e.g., an image frame). To this end, the sensor module 500 may include a sensing device (for example, at least one of various kinds of sensors such as an imaging device, an image sensor, a light detection and ranging (LIDAR) sensor, an ultrasonic sensor, an infrared sensor, a microphone, and/or a haptic sensor), or may receive a sensing signal from a sensing device. In an embodiment, the sensor module 500 may provide an image frame to the neural network device 100. For example, the sensor module 500 may include an image sensor and may photograph an external environment of the electronic system 10A to generate a video stream, and moreover, the sensor module 500 may sequentially provide continuous image frames of the video stream to the neural network device 100. The sensor module 500 may be configured to store the image frame in the memory 400 and/or to provide the image frame to the neural network device 100.

The electronic system 10A according to an embodiment may use a value distribution so as to select an optimal action from among a plurality of actions corresponding to a current state received as an input, and the value distribution may include at least one Gaussian graph. Also, the at least one Gaussian graph included in the value distribution may be defined by a value weight, a value mean, and a value standard deviation, and the electronic system 10 may output a value weight, a value mean, and a value standard deviation as a deep learning result of the neural network device 100 and may select an action on the basis thereof, for example an optical action.

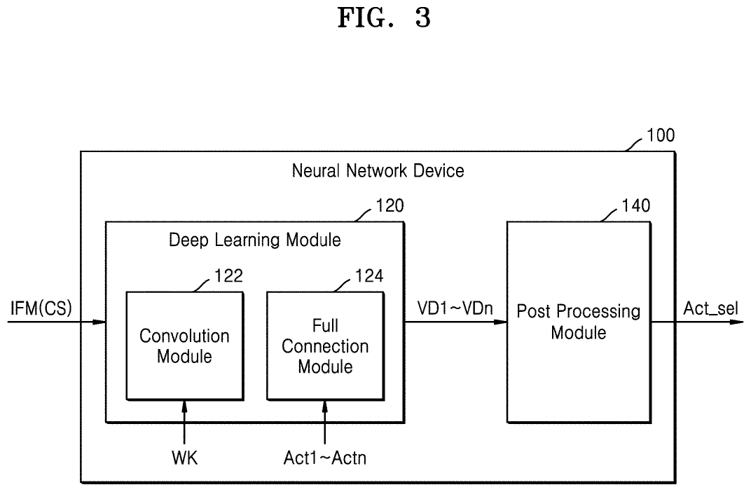

FIG. 3 is a block diagram illustrating a neural network device 100 according to an embodiment.

Referring to FIG. 3, the neural network device 100 may include a deep learning module 120 and a post-processing module 140.

The deep learning module 120 may receive a current state CS as an input feature map IFM in the form of data and may perform deep learning on the current state CS to generate first to n^{th} value distributions VD1 to VDn. In an embodiment, the deep learning module 120 may generate the first to n^{th} value distributions VD1 to VDn respectively corresponding to a plurality of actions Act1 to Actn capable of being performed on the current state CS. In an embodiment, the deep learning module 120 may generate the first to n^{th} value distributions VD1 to VDn respectively corresponding to the plurality of actions Act1 to Actn by using distributional reinforcement learning.

Reinforcement learning may denote a machine learning method that learns a process of determining an action which is to be optimally taken in the current state CS. A reward may be provided in an external environment whenever an action is taken, and learning may be performed for maximizing the reward. The reward may be calculated in the form of value return, and according to the distributional reinforcement learning, the value return may be implemented in the form of value distribution.

In the reinforcement learning, although a current reward value is small, an action has to be selected for maximizing a total sum of reward values including a value which is to be obtained later, and moreover, since a user taking an action does not know an action which allows a sum of reward values to be maximized, the user has to determine an optimal selection while taking an action in various manners, based on the future.

In an embodiment, the deep learning module 120 may generate value distributions respectively corresponding to the plurality of actions Act1 to Actn corresponding to the current state CS so that the value distributions include one or more Gaussian graphs defined by an average value, a weight value, and a variance value, and moreover, the deep learning module 120 may express each of the value distributions as an average value, a weight value, and a variance value of the Gaussian graphs to express a result value of the deep learning module 120 as a limited network parameter.

Herein, an average value of Gaussian graphs constituting a value distribution may be referred to as a value mean, a weight value of the Gaussian graphs may be referred to as a probability weight, and a variance value of the Gaussian graphs may be referred to as a value standard deviation.

The deep learning module 120 may output the generated first to n^{th} value distributions VD1 to VDn to the post-processing module 140. In an embodiment, the deep learning module 120 may output network parameters (e.g., a value mean, a probability weight, and a value standard deviation of a plurality of Gaussian graphs) constituting the first to n^{th} value distributions VD1 to VDn to the post-processing module 140.

The deep learning module 120 may include a convolution module 122 and a full connection module 124. The convolution module 122 may receive a weight kernel WK and may perform a convolution operation on the current state CS received as the weight kernel WK and the input feature map IFM to generate an output feature map.

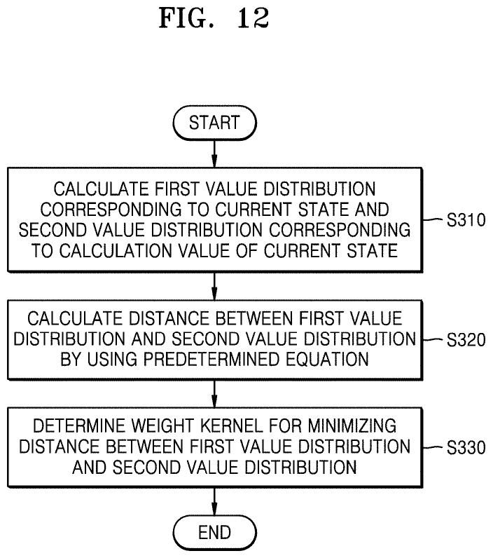

In an embodiment, the neural network device 100 may determine the weight kernel WK for optimizing a value return on the basis of distance information between a calculation value and a real value of each of the first to n^{th} value distributions VD1 to VDn. This will be described below with reference to FIG. 12.

The full connection module 124 may fully connect the plurality of actions Act1 to Actn to elements of an output feature map to generate the first to n^{th} value distributions VD1 to VDn, respectively. The full connection may denote performing arithmetic operations corresponding to all connections between the plurality of actions Act1 to Actn and the elements of the output feature map generated as a convolution result, and thus, based on the full connection, an operation value corresponding to all elements of the output feature map respectively corresponding to the plurality of actions Act1 to Actn may be output as a value return.

According to an embodiment, the full connection module 124 may output, as the value return, at least one Gaussian graph constituting a value distribution. Also, in an embodiment, the full connection module 124 may output a value mean, a probability weight, and a value standard deviation of each of the at least one Gaussian graph as the value return.

The post-processing module 140 may receive network parameters corresponding to the first to n^{th} value distributions VD1 to VDn and may select an optimal action Act_sel from among the plurality of actions Act1 to Actn on the basis of the first to n^{th} value distributions VD1 to VDn. In an embodiment, the post-processing module 140 may calculate an average value of the first to n^{th} value distributions VD1 to VDn on the basis of the network parameters and may select an action, corresponding to a value distribution where the average value is largest, as the optimal action Act_sel. In an embodiment, each of the first to n^{th} value distributions VD1 to VDn may have a quality value q corresponding to an x axis and a probability value p(q) based on the value q corresponding to a y axis, and the average value AV may be expressed as the following Equation 1.

AV=∫q·p(q)dq [Equation 1]

The convolution module 122, full connection module 124, and post-processing module 140 may include processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), and programmable logic unit, a microprocessor, application-specific integrated circuit (ASIC), etc.

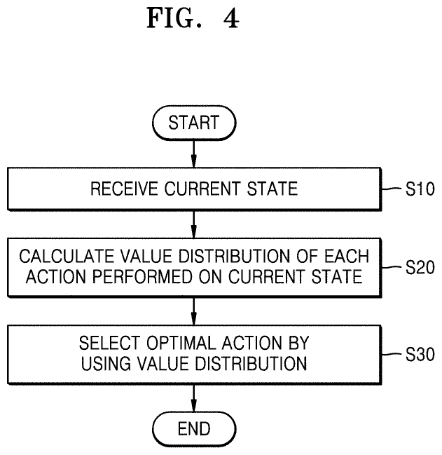

FIG. 4 is a flowchart illustrating an operating method of a neural network device 100 according to an embodiment.

Referring to FIGS. 3 and 4, the neural network device 100 may receive the current state CS as an input in operation S10. The neural network device 100 may calculate the first to n^{th} value distributions VD1 to VDn respectively corresponding to the plurality of actions Act1 to Actn capable of being performed on the current state CS.

In an embodiment, the neural network device 100 may calculate the first to n^{th} value distributions VD1 to VDn including one or more Gaussian graphs defined by a value mean, a probability weight, and a value standard deviation and respectively corresponding to the plurality of actions Act1 to Actn by using the distributional reinforcement learning.

The neural network device 100 may select an action from among the plurality of actions Act1 to Actn by using the first to n^{th} value distributions VD1 to VDn in operation S30. In an embodiment, the neural network device 100 may select an optimal action based on the first to n^{th} value distributions VD1 to VDn. For example, the neural network device 100 may calculate an average value of each of the first to n^{th} value distributions VD1 to VDn and may select an action, corresponding to a value distribution where the average value is largest, as the optimal action.

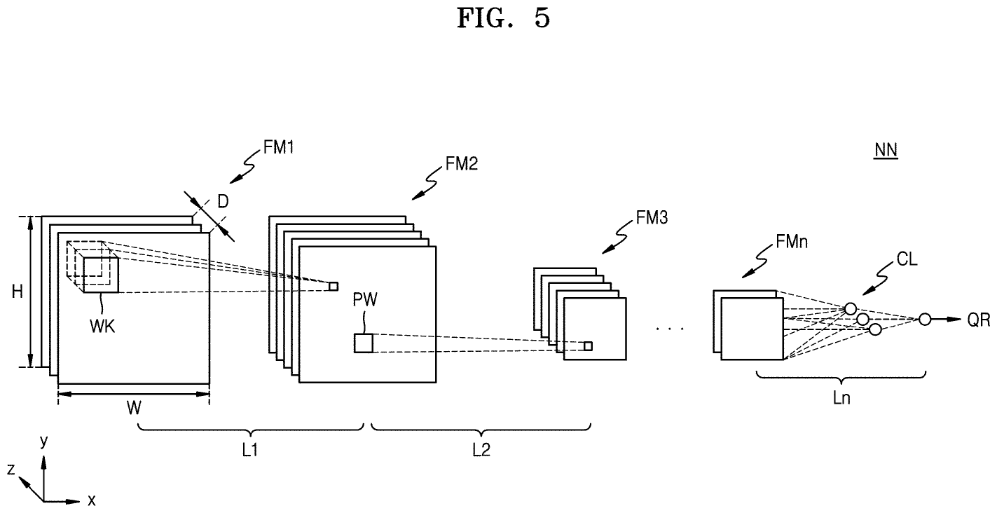

FIG. 5 is a diagram illustrating a neural network according to an embodiment. In detail, FIG. 5 illustrates a structure of a convolution neural network as an example of a neural network structure.

Referring to FIG. 5, a neural network NN may include a plurality of layers (for example, first to n^{th} layers) L1 to Ln. Each of the plurality of layers L1 to Ln may be a linear layer or a nonlinear layer, and in an embodiment, a combination of at least one linear layer and/or at least one nonlinear layer may be referred to as one layer. For example, the linear layer may include a convolution layer and a fully connected layer, and the nonlinear layer may include a pooling layer and an activation layer.

For example, the first layer L1 may comprise a convolution layer, the second layer L2 may comprise a pooling layer, and the n^{th} layer Ln may comprise an output layer and/or a fully connected layer. The neural network NN may further include an activation layer, and moreover, may further include a layer for performing a different kind of operation.

Each of the plurality of layers L1 to Ln may receive, as an input feature map, data input thereto (for example, an image frame) or a feature map generated in a previous layer and may perform an arithmetic operation on the input feature map to generate a value return VR. In an embodiment, the value return VR may include a value distribution including at least one Gaussian graph or network parameters (for example, a value mean, a probability weight, and a value standard deviation) corresponding to the at least one Gaussian graph.

The feature map may denote data where various features of input data are expressed. A plurality of feature maps (for example, first, second, and n^{th} feature maps) FM1, FM2, FM3, and FMn may have, for example, a two-dimensional (2D) matrix form or a 3D matrix (or tensor) form. In an embodiment, the input first feature map FM1 may comprise data corresponding to a current state. The feature maps FM1, FM2, FM3, and FMn may have a width W (e.g., a column), a height H (e.g., a row), and a depth D; and may respectively correspond to an x axis, a y axis, and a z axis of coordinates. The depth D may be referred to as the number of channels.

The first layer L1 may perform convolution between the first feature map FM1 and the weight kernel WK to generate the second feature map FM2. The weight kernel WK may filter the first feature map FM1 and may be referred to as a filter or a map. A depth (.e.g., the number of channels) of the weight kernel WK may be the same as a depth (e.g., the number of channels) of the first feature map FM1 and may perform convolution between the same channels of the weight kernel WK and the first feature map FM1. The weight kernel WK may be shifted by a crossing manner by using the first feature map FM1 as a sliding window. The amount of shift may be referred to as a stride length or a stride.

While each shift is being performed, each of the weight values included in the weight kernel WK may be multiplied by all pixel data and summated in a region overlapping the first feature map FM1. Pieces of extraction data of the first feature map FM1 in a region where each of weight values included in the weight kernel WK overlaps the first feature map FM1 may be referred to as extraction data. As convolution between the first feature map FM1 and the weight kernel WK is performed, one channel of the second feature map FM2 may be generated. In FIG. 3, one weight kernel WK is illustrated, but substantially, convolution between a plurality of weight maps and the first feature map FM1 may be performed, thereby generating a plurality of channels of the second feature map FM2. In other words, the number of channels of the second feature map FM2 may correspond to the number of weight maps.

The second layer L2 may vary the spatial size of the second feature map FM2 through pooling to generate the third feature map FM3. Pooling may be referred to as sampling or down-sampling. A 2D pooling window PW may be shifted in the second feature map FM2 by units of sizes of the pooling window, and a maximum value (or an average value of pieces of pixel data) among pieces of pixel data in a region overlapping the pooling window PW may be selected. Therefore, the third feature map FM3 where a spatial size has varied may be generated from the second feature map FM2. The number of channels of the third feature map FM3 may be the same as the number of channels of the second feature map FM2. In an embodiment, the third feature map FM3 may correspond to an output feature map on which convolution described above with reference to FIG. 3 is completed.

The n^{th} layer Ln may combine features of the n^{th} feature map FMn to classify a class CL of input data. Also, the n^{th} layer Ln may generate a value return VR corresponding to a class. In an embodiment, the input data may correspond to data corresponding to a current state, and the n^{th} layer Ln may extract classes corresponding to a plurality of actions from the n^{th} feature map FMn provided from a previous layer to generate the value return VR for determining an optimal action. The n^{th} layer Ln may be performed by the full connection module 124 (see FIG. 3) described above with reference to FIG. 3.

According to an embodiment, the value return VR may be expressed as a probability distribution of a value corresponding to each of a plurality of actions. Herein, as described above, a neural network for calculating a probability distribution of a value return possible for each current state-action pair may be defined as a value distribution network, and in an embodiment, the value distribution network may output, as a deep learning result, a network parameter defining a probability distribution of a value return.

FIGS. 6A and 6B are diagrams for describing a convolution operation of a neural network according to an embodiment.

Referring to FIG. 6A, input feature maps 201 may include D number of channels, and an input feature map of each of the channels may have an H row, W column size (where D, H, and W are natural numbers). Each of kernels 202 may have an R row, S column size, and the kernels 202 may include a number of channels corresponding to the depth D of the input feature maps 201 (where R and S are natural numbers). Output feature maps 203 may be generated by performing a 3D convolution operation between the input feature maps 201 and the kernels 202 and may include Y number of channels on the basis of a convolution operation (where Y is a natural number).

A process of generating an output feature map through a convolution operation between one input feature map and one kernel will be described with reference to FIG. 6B, and the 2D convolution operation described above with reference to FIG. 5B may be performed between input feature maps 201 of all channels and kernels 220 of all channels, thereby generating output feature maps 203 of all channels.

Referring to FIG. 6B, for convenience of description, an input feature map 210 has been illustrated as having a 6×6 size, an original kernel 220 has been illustrated as having a 3×3 size, and an output feature map 230 has been illustrated as having a 4×4 size, but the present embodiment is not limited thereto and a neural network may be implemented with feature maps and kernels having various sizes. Also, values defined in the input feature map 210, the original kernel 220, and the output feature map 230 are merely example values, and embodiments are not limited thereto.

The original kernel 220 may perform a convolution operation while sliding by units of windows having a 3×3 size in the input feature map 210. The convolution operation may denote an arithmetic operation of calculating each feature data of the output feature map 230 by summating values obtained by multiplying each feature data of a window of the input feature map 210 by weight values of each corresponding position in the original kernel 220. Pieces of data included in a window of the input feature map 210 and multiplied by weight values may be referred to as extraction data extracted from the input feature map 210. In detail, the original kernel 220 may first perform a convolution operation on first extraction data 211 of the input feature map 210. That is, feature data “1, 2, 3, 4, 5, 6, 7, 8, and 9” of the first extraction data 211 may be respectively multiplied by weight values “−1, −3, 4, 7, −2, −1, −5, 3, and 1” of the original kernel 220 corresponding thereto, thereby obtaining values “−1, −6, 12, 28, −10, −6, −35, 24, and 9”. Subsequently, 15 which is a result obtained by summating the obtained values “−1, −6, 12, 28, −10, −6, −35, 24, and 9” may be calculated, and feature data 231 of first row, first column of the output feature map 230 may be determined as 15. Here, the feature data 231 of first row, first column of the output feature map 230 may correspond to the first extraction data 211. In this manner, 4 which is feature data 232 of first row, second column of the output feature map 230 may be determined by performing a convolution operation between second extraction data 212 of the input feature map 210 and the original kernel 220. Finally, 11 which is feature data 233 of fourth row, fourth column of the output feature map 230 may be determined by performing a convolution operation between the original kernel 220 and sixteenth extraction data 213 which is last extraction data of the input feature map 210.

In other words, a convolution operation between one input feature map 210 and one original kernel 220 may be processed by repeatedly performing multiplication of extraction data of the input feature map 210 and corresponding weight values of the original kernel 220 and addition of multiplication results, and the output feature map 230 may be generated as a result of the convolution operation.

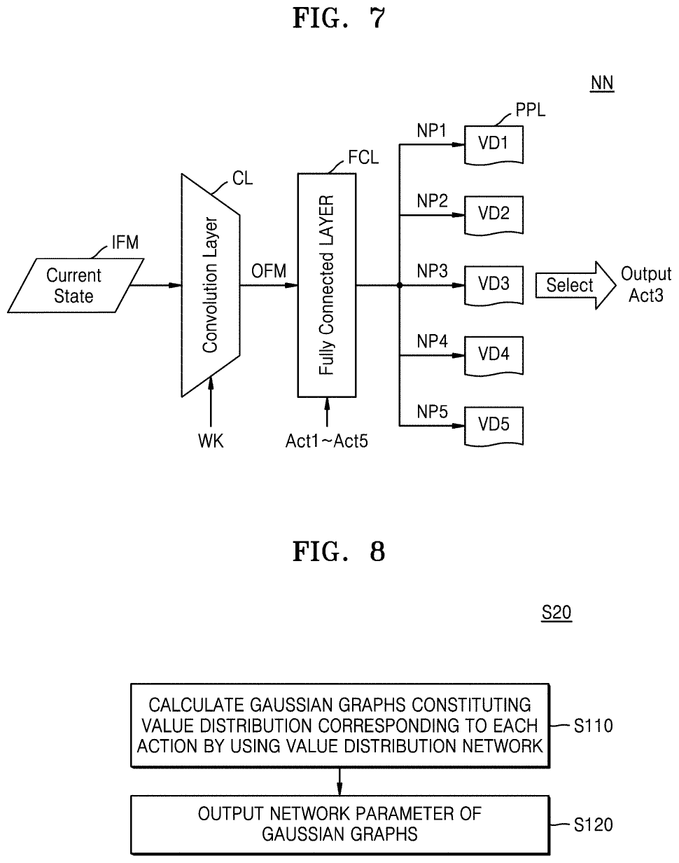

FIG. 7 is a diagram illustrating a neural network NN according to an embodiment.

Referring to FIG. 7, the neural network NN may include a convolution layer CL, a full connection layer FCL, and a post-processing layer PPL. The convolution layer CL may receive an input feature map IFM corresponding to a current state and may perform a convolution operation on a weight kernel WK to generate an output feature map OFM. The convolution layer CL may further include a pooling layer described above with reference to FIG. 5. An operation of the convolution layer CL has been described above with reference to FIGS. 5 to 6B, and thus, its description is omitted.

The full connection layer FCL may fully connect a plurality of actions Act1 to Act5 to elements of the output feature map OFM to calculate a plurality of value distributions VD1 to VD5 respectively corresponding to the plurality of actions Act1 to Act5 and to generate a plurality of network parameters NP1 to NP5 corresponding thereto. In an embodiment, each of the value distributions VD1 to VD5 may include at least one Gaussian graph, and the plurality of network parameters NP1 to NP5 may include a parameter representing at least one Gaussian graph. In an embodiment, the network parameters NP1 to NP5 may include a value mean, a probability weight, and a value standard deviation of each of the at least one Gaussian graph.

The post-processing layer PPL may determine an optimal action on the basis of the plurality of network parameters NP1 to NP5. In an embodiment, the post-processing layer PPL may calculate an average value of each of the plurality of value distributions VD1 to VD5 on the basis of the plurality of network parameters NP1 to NP5, and in a value distribution (the embodiment of FIG. 7) where an average value is largest, an action corresponding to a third value distribution VD3 of the plurality of value distributions VD1 to VD5 may be determined as an optimal action. In the embodiment of FIG. 7, a third action Act3 of the plurality of actions Act1 to Act5 may be determined as an optimal action.

FIG. 8 is a flowchart illustrating an operating method of a neural network device according to an embodiment. In detail, FIG. 8 is a diagram illustrating in detail a method (S20) of calculating the value distribution of FIG. 4.

Referring to FIGS. 3 and 8, the deep learning module 120 may calculate a plurality of Gaussian graphs constituting value distributions respectively corresponding to a plurality of actions by using a value distribution network in operation S110. The value distribution network may output, as a result of deep learning, a value distribution representing a probability distribution of an action-based value return, and in an embodiment, the deep learning module 120 may calculate a value distribution so as to include a plurality of Gaussian graphs.

The deep learning module 120 may output a network parameter of each of a plurality of Gaussian graphs as a result of deep learning (or machine learning) in operation S120. In an embodiment, the deep learning module 120 may output a value mean, a probability weight, and a value standard deviation of each of the plurality of Gaussian graphs as a network parameter.

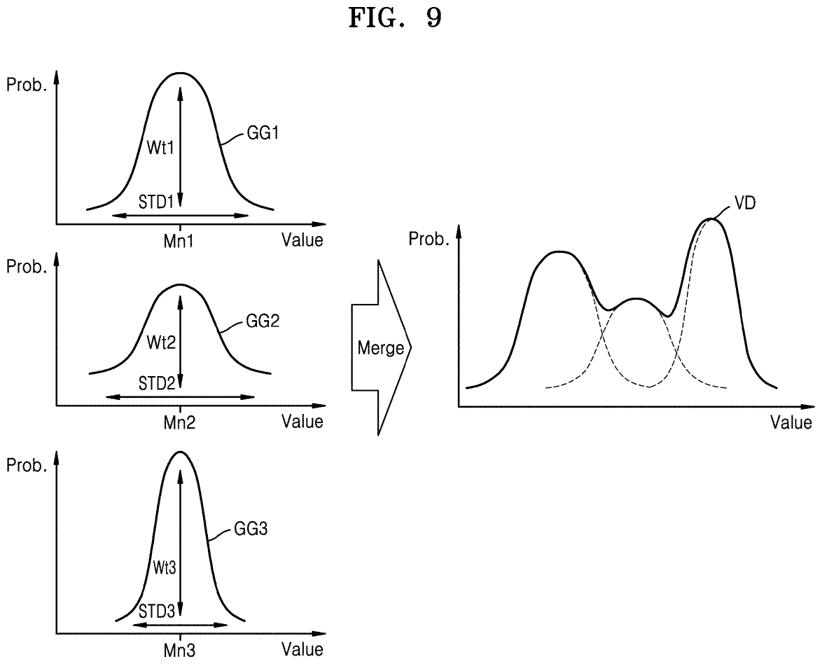

FIG. 9 is a diagram illustrating an operation of a neural network device according to an embodiment. In detail, FIG. 9 illustrates a method of calculating a value distribution as a deep learning result. In graphs of FIG. 9, the abscissa axis represents a value of each action, and the ordinate axis represents a probability for having each value.

Referring to FIGS. 3 and 9, the deep learning module 120 may calculate a value distribution VD as a result of a first action corresponding to a current state by using a value distribution network. The value distribution VD may be formed by merging first to third Gaussian graphs GG1 to GG3.

The first Gaussian graph GG1 may be symmetrical with respect to a first value mean Mn1. Also, the first Gaussian graph GG1 may laterally spread to correspond to a first value standard deviation STD1 and may have a maximum value corresponding to a first probability weight Wt1.

The second Gaussian graph GG2 may be symmetrical with respect to a second value mean Mn2. Also, the second Gaussian graph GG2 may laterally spread to correspond to a second value standard deviation STD2 and may have a maximum value corresponding to a second probability weight Wt2.

The third Gaussian graph GG3 may be symmetrical with respect to a third value mean Mn3. Also, the third Gaussian graph GG3 may laterally spread to correspond to a third value standard deviation STD3 and may have a maximum value corresponding to a third probability weight Wt3.

The value distribution VD may be formed by merging the first to third Gaussian graphs GG1 to GG3, and thus, may be defined by network parameters of the first to third Gaussian graphs GG1 to GG3. In an embodiment, the deep learning module 120 may calculate the value distribution VD by using the value distribution network and may output, as result values thereof, the first to third value means Mn1 to Mn3, the first to third value standard deviations STD1 to STD3, and the first to third probability weights Wt1 to Wt3.

The post-processing module 140 may calculate an action-based value return by using the first to third value means Mn1 to Mn3, the first to third value standard deviations STD1 to STD3, and the first to third probability weights Wt1 to Wt3.

FIG. 9 illustrates an embodiment where the value distribution VD includes three Gaussian graphs GG1 to GG3, but this is merely an example embodiment and the value distribution VD may include more or fewer Gaussian graphs than the three illustrated.

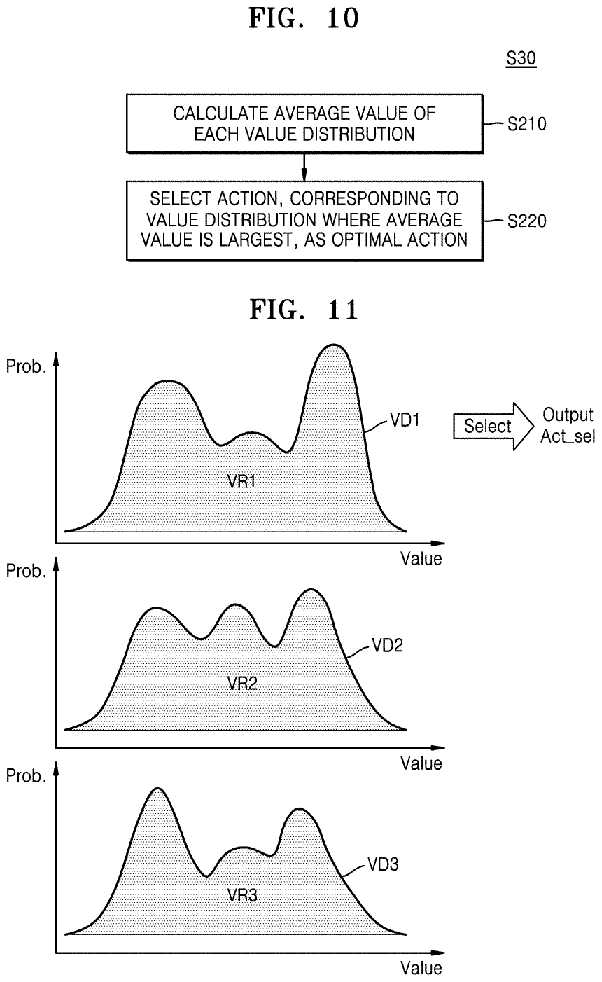

FIG. 10 is a flowchart illustrating an operating method of a neural network device according to an embodiment. In detail, FIG. 10 is a diagram illustrating in detail a method (S30) of selecting the optimal action of FIG. 4.

Referring to FIGS. 3 and 10, the post-processing module 140 may calculate an average value of each of a plurality of value distributions in operation S210. The average value may correspond to a value return of an action corresponding to each value distribution. In an embodiment, the post-processing module 140 may receive network parameters corresponding to the plurality of value distributions and may calculate an average value of each value distribution by using the received network parameters.

According to an embodiment, since each value distribution includes a plurality of Gaussian graphs, the post-processing module 140 may receive a value mean, a probability weight, and a value standard deviation and may calculate a value return by using the received value mean, probability weight, and value standard deviation.

The post-processing module 140 may select, as an optimal action, an action corresponding to a value distribution where the calculated average value is largest in operation S220.

FIG. 11 is a diagram illustrating an operation of a neural network device according to an embodiment. In detail, FIG. 11 illustrates a method of selecting an optimal action. In graphs of FIG. 11, the abscissa axis represents a value of each action, and the ordinate axis represents a probability for having each value.

Referring to FIGS. 3 and 11, the neural network device 100 may calculate a first value distribution VD1 corresponding to a first action, a second value distribution VD2 corresponding to a second action, and a third value distribution VD3 corresponding to a third action. In an embodiment, each of the first to third value distributions VD1 to VD3 may include three Gaussian graphs, and the neural network device 100 may calculate the first value distribution VD1, the second value distribution VD2, and the third value distribution VD3 by using network parameters corresponding to the three Gaussian graphs.

The neural network device 100 may calculate an average value of the first value distribution VD1 to calculate a first value return value VR1. In an embodiment, the first value return value VR1 may be a value obtained by applying Equation 1 to the first value distribution VD1. According to an embodiment, the neural network device 100 may summate average values of a plurality of Gaussian graphs constituting the first value distribution VD1 to calculate the first value return value VR1.

In a similar manner, the neural network device 100 may calculate a second value return value VR2 corresponding to the second value distribution VD2 and a third value return value VR3 corresponding to the third value distribution VD3.

The neural network device 100 may determine an optimal action on the basis of the first to third value return values VR1 to VR3. In an embodiment, the neural network device 100 may determine, as an optimal action, an action corresponding to a value distribution having a largest value among the first to third value return values VR1 to VR3.

In the embodiment of FIG. 11, the first value return value VR1 may have a large value compared to the second value return value VR2 and the third value return value VR3, and the neural network device 100 may output a first action, corresponding to the first value return value VR1, as an optimal action Act_sel.

FIG. 12 is a flowchart illustrating an operating method of an electronic system 10 according to an embodiment. In detail, FIG. 12 illustrates an operation of adaptively determining a weight kernel.

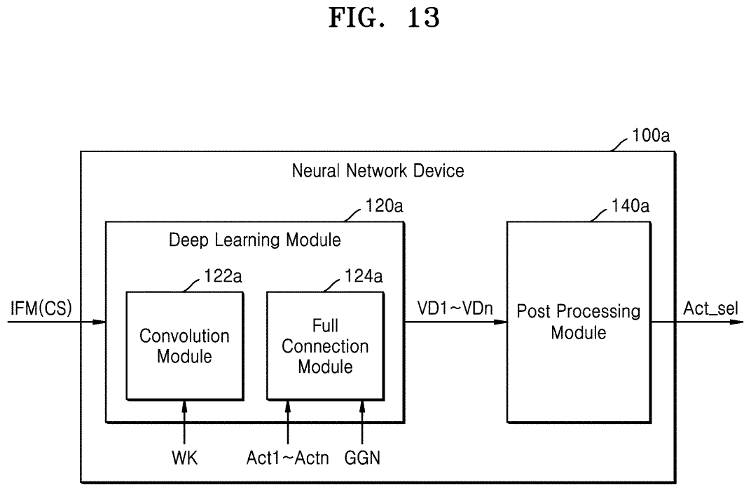

Referring to FIGS. 2 and 13, the electronic system 10 may calculate a first value distribution corresponding to a current state and a second value distribution corresponding to a calculation value of the current state in operation S310. In an embodiment, the first value distribution may be a graph showing a sum of all value returns after the current state, and the second value distribution may be a graph showing a prediction value return of all actions possible in the current state and a sum of all value returns after a next state.

The electronic system 10 may calculate a distance between the first value distribution and the second value distribution by using a predetermined equation in operation S320. In an embodiment, the electronic system 10 may parameterize the first value distribution and the second value distribution as a mixture of Gaussians (MoG) distribution and may calculate a distance between the first value distribution and the second value distribution by using Jensen-Tsallis distance (JTD) defined as a distance criterion as in the following Equation 2.

JTD(X,Y)=(∫_{R}(f_{X}(r)−f_{Y}(r))²dr)^{1/2} [Equation 2]

Here, f_{X}(r) may denote a first value distribution based on a value r, and f_{Y}(r) may denote a second value distribution based on the value r. Also, R may denote a set of possible quality values.

The electronic system 10 may determine a weight kernel for minimizing the distance between the first value distribution and the second value distribution in operation S330. In an embodiment, the electronic system 10 may adaptively determine a weight kernel for minimizing a result value of Equation 2 described above.

According to an embodiment, a value distribution may include a plurality of Gaussian graphs, and thus, a distance between value distributions based on Equation 2 may be calculated by using limited network parameters of the plurality of Gaussian graphs.

FIG. 13 is a block diagram illustrating a neural network device 100a according to an embodiment. Description which is the same as or similar to the description of FIG. 3 is omitted.

Referring to FIG. 13, the neural network device 100a may include a deep learning module 120a and a post-processing module 140a, and the deep learning module 120a may include a convolution module 122a and a full connection module 124a. The convolution module 122a and the post-processing module 140a may be the same as or similar to the convolution module 122 and the post-processing module 140 of FIG. 3.

The full connection module 124a may receive the number of Gaussian graphs GGN and may calculate a plurality of value distributions VD1 to VDn on the basis of the number of Gaussian graphs GGN. In an embodiment, the plurality of value distributions VD1 to VDn may include one or more Gaussian graphs, and the number of Gaussian graphs GGN may include information about the number of Gaussian graphs included in the plurality of value distributions VD1 to VDn.

The full connection module 124a may determine the number of Gaussian graphs constituting a value distribution on the basis of the number of Gaussian graphs GGN and may output a plurality of network parameters on the basis of the determined number of Gaussian graphs.

According to an embodiment, an accuracy of a value return and the number of calculations may be adaptively adjusted by adaptively adjusting the number of Gaussian graphs.

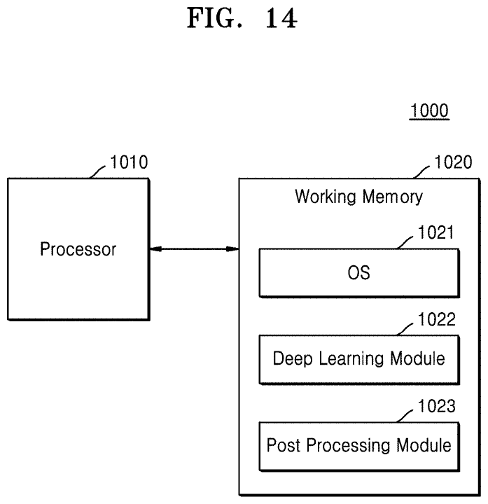

FIG. 14 is a block diagram illustrating an application processor 1000 according to an embodiment. The application processor 1000 may be a semiconductor chip and/or may be implemented as a system on chip (SoC).

Referring to FIG. 14, the application processor 1000 may include a processor 1010 and a working memory 1020. Also, although not shown in FIG. 14, the application processor 1000 may further include one or more IP modules connected to a system bus. The working memory 1020 may store pieces of software such as various kinds of programs and instructions associated with an operation of a system including the application processor 1000, and for example, may include an OS 1021, a deep learning module 1022, and a post-processing module 1023. The deep learning module 1022 and the post-processing module 1023 may be configured with a set of instructions for performing the operations according to embodiments described above with reference to FIGS. 1 to 13.

In an embodiment, the processor 1010 may load a set of instructions included in the deep learning module 1022 and the post-processing module 1023 loaded into the working memory 1020, and thus, may perform the operations according to embodiments described above with reference to FIGS. 1 to 13. In an embodiment, the processor 1010 may load a set of instructions included in the deep learning module 1022 to calculate a value distribution including a Gaussian graph for each operation capable of being performed in a current state and may load a set of instructions included in the post-processing module 1023 to determine, as an optimal action, an action corresponding to a value distribution, where a value return is highest, of value distributions.

One processor 1010 is illustrated in FIG. 14, but the application processor 1000 may include a plurality of processors. In this case, some of the plurality of processors may correspond to general processors, and the other processors may be dedicated processors for executing a neural network model.

While the inventive concepts have been particularly shown and described with reference to embodiments thereof, it will be understood that various changes in form and details may be made therein without departing from the spirit and scope of the following claims. It is to be appreciated that other example embodiments may include fewer (such as one) or additional elements or components; may rename and/or rearrange certain elements or components; may omit or include duplicates of certain elements or components; may organize such elements or components in a different manner, such as combining the deep learning module 120 and the post-processing module 140 into a single circuit; and/or may utilize a variety of technology for each element or component, such as hardware, software, or a combination of hardware and software. Some example embodiments may include multiple components or elements in one device, while other example embodiments may distribute such components or elements in multiple intercommunicating devices. Some example embodiments may include sharing resources, such as a processor or a memory circuit, among several elements or components either in series (such as sequentially) and/or in parallel (such as concurrently), while other example embodiments may include different sets of resources for different elements or components. All such variations that are reasonably and logically possible, and that are not contradictory with other statements, are intended to be included in this disclosure, the scope of which is to be understood as being defined by the claims.

What is claimed is:

1. A method of selecting an action based on deep learning, executed by a device including a neural network device, the method comprising:
receiving, by the neural network device, a current state as an input;
calculating, by the neural network device, a value distribution corresponding to each of a plurality of actions to be performed on the current state; and
selecting, by the neural network device, an action from among the plurality of actions based on the value distribution,
wherein the value distribution includes at least one Gaussian graph following a Gaussian distribution.

2. The method of claim 1, wherein the calculating of the value distribution includes calculating the at least one Gaussian graph by using a value distribution network,
the value distribution network includes a distributional neural network configured to output a plurality of network parameters defining a probability distribution of a value return possible for each current state-action pair, and
the value return includes an estimation value of a value obtained as a result of each action performed on the current state.

3. The method of claim 2, wherein the plurality of network parameters includes, of each of the at least one Gaussian graph, at least one of a probability weight, a value mean, and a value standard deviation.

4. The method of claim 1, wherein the value distribution includes a graph of overlapping a first Gaussian graph, a second Gaussian graph, and a third Gaussian graph, the calculating of the value distribution includes
calculating, by the neural network device, a first probability weight, a first value mean, and a first value standard deviation of the first Gaussian graph by using a value distribution network;
calculating, by the neural network device, a second probability weight, a second value mean, and a second value standard deviation of the second Gaussian graph by using the value distribution network;
calculating, by the neural network device, a third probability weight, a third value mean, and a third value standard deviation of the third Gaussian graph by using the value distribution network; and
generating, by the neural network device, the value distribution by allowing the first Gaussian graph, the second Gaussian graph, and the third Gaussian graph to overlap one another based on the results of the calculations.

5. The method of claim 1, wherein the calculating of the value distribution includes:
receiving, by the neural network device, a number of Gaussian graphs for generating the value distribution;
calculating, by the neural network device, a plurality of Gaussian graphs by using a value distribution network based on the number of Gaussian graphs; and
generating, by the neural network device, the value distribution by overlapping the calculated plurality of Gaussian graphs.

6. The method of claim 1, wherein the selecting of the action includes:
calculating, by the neural network device, an average value of each of the value distributions respectively corresponding to the plurality of actions; and
determining, by the neural network device, an action, corresponding to the value distribution where the average value is largest, as an optimal action,
selecting the optimal action as the selected option.

7. The method of claim 1, wherein the calculating of the value distribution includes:
performing, by the neural network device, a convolution operation on an input feature map corresponding to the current state by using a weight kernel; and
generating, by the neural network device, a plurality of Gaussian graphs based on a full connection between each of the plurality of actions and elements of an output feature map generated by a result of the convolution operation.

8. The method of claim 7, further including setting the weight kernel for minimizing a distance difference between a first value distribution corresponding to the current state and a second value distribution corresponding to a calculation value of the current state.

9. The method of claim 8, wherein the first value distribution includes a plurality of first Gaussian graphs corresponding to value returns of the current state, and
the second value distribution includes a plurality of second Gaussian graphs corresponding to a sum of value returns of a state next to the current state and value returns of the plurality of actions.

10. The method of claim 9, wherein the setting of the weight kernel includes:
calculating a distance between the plurality of first Gaussian graphs and the plurality of second Gaussian graphs based on a distance calculation equation; and
determining the weight kernel for minimizing the distance.

11. A method of selecting an action based on deep learning, executed by a device including a neural network device, the method comprising:
receiving, by the neural network device, a current state as an input;
performing, by the neural network device, a convolution operation on an input feature map corresponding to the current state by using a weight kernel; and
setting, by the neural network device, the weight kernel for minimizing a distance difference between a first value distribution corresponding to the current state and a second value distribution corresponding to a calculation value of the current state,
wherein the first value distribution includes a plurality of first Gaussian graphs corresponding to value returns of the current state, and
the second value distribution includes a plurality of second Gaussian graphs corresponding to a sum of value returns of a state next to the current state and value returns of the plurality of actions.

12. The method of claim 11, wherein the setting of the weight kernel includes:
calculating a distance between the plurality of first Gaussian graphs and the plurality of second Gaussian graphs based on a distance calculation equation; and
determining the weight kernel for minimizing the distance.

13. A neural network device comprising:
processing circuitry configured to:
receive a current state and calculate a value distribution corresponding to each of a plurality of actions to be performed on the current state by using a deep learning model; and
select an action from among the plurality of actions based on the value distribution, wherein the value distribution includes at least one Gaussian graph following a Gaussian distribution.

14. The neural network device of claim 13, wherein the processing circuitry is configured to calculate the at least one Gaussian graph by using a value distribution network,
the value distribution network includes a distributional neural network configured to output a plurality of network parameters defining a probability distribution of a value return possible for each current state-action pair, and
the value return includes an estimation value of a value obtained as a result of each action performed on the current state.

15. The neural network device of claim 14, wherein the plurality of network parameters includes, of each of the at least one Gaussian graph, at least one of a probability weight, a value mean, and a value standard deviation.

16. The neural network device of claim 13, wherein the processing circuitry is further configured to
receive a number of Gaussian graphs,
calculate a plurality of Gaussian graphs by using a value distribution network based on the received number of Gaussian graphs, and
generate the value distribution by overlapping the calculated plurality of Gaussian graphs.

17. The neural network device of claim 13, wherein the processing circuitry is configured to calculate an average value of each of the value distributions respectively corresponding to the plurality of actions and determine an action corresponding to a value distribution where the average value is largest as an optimal action.

18. The neural network device of claim 13, wherein the processing circuitry is further configured to
perform a convolution operation on an input feature map corresponding to the current state by using a weight kernel; and
generate a plurality of Gaussian graphs based on a full connection between each of the plurality of actions and elements of an output feature map generated based on the convolution operation.

19. The neural network device of claim 18, wherein the processing circuitry is configured to set the weight kernel to minimize a distance difference between a first value distribution corresponding to the current state and a second value distribution corresponding to a calculation value of the current state.

20. The neural network device of claim 19, wherein the first value distribution includes a plurality of first Gaussian graphs corresponding to value returns of the current state, and
the second value distribution includes a plurality of second Gaussian graphs corresponding to a sum of value returns of a state next to the current state and value returns of the plurality of actions.
